(19) United States
(12) Patent Application Publication
(10) Pub. No.: US 2026/0343648 A1
(43) Pub. Date: Oct. 29, 2026

(54) DRONE BASE STATION COVERAGE EXTENSION IN A NETWORK

(71) Applicant: Rakuten Mobile, Inc., Tokyo (JP)

(72) Inventors: Saurabh VERMA, Tokyo (JP); Masahiko NANRI, Tokyo (JP)

(73) Assignee: Rakuten Mobile, Inc., Tokyo (JP)

(21) Appl. No.: 19/191,003

(22) Filed: Apr. 28, 2025

(51) Int. Cl. H04W 76/15; H04W 64/00; H04W 84/06

(52) U.S. Cl. CPC H04W 76/15; H04W 64/00; H04W 84/06

(57) ABSTRACT

Provided are apparatus, method, and device for automatically perform drone base station control. According to example embodiments, the apparatus may be configured to: perform dual connectivity operation comprising a primary connection operation and a secondary connection operation; wherein the primary connection operation may include: receive, from a satellite, drone control data comprising data associated with control of a target drone; and control the target drone based on the drone control data; and wherein the secondary connection operation may include: receive, from an intermediate drone, service data comprising data associated with services using mmWave spectrum; and transmit the service data to a device under a coverage area associated with the target drone and to a forward drone using the mmWave spectrum.

### FIELD

The present disclosure relate to coverage extension for drone base station in a telecommunications network.

### BACKGROUND

The information disclosed in this background section is only for enhancement of understanding of the general background of the disclosure and should not be taken as an acknowledgement or any form of suggestion that this information forms the prior art already known to a person skilled in the art.

A base station mounted drone refers a technology wherein a drone, such as an unmanned aerial vehicle (UAV), is mounted with various equipment that enables the drone to act as a base station. Such technology extends the overall coverage area of the network by deploying base stations, via the drones, at remote locations that is usually outside of the coverage area provided by terrestrial base stations or locations encountering natural disasters.

Accordingly, services may be provided to user equipment and devices at such remote locations and locations encountering natural disasters via the base station mounted drone.

### SUMMARY

Example embodiments of the present disclosure automatically perform drone base station control. As such, example embodiments of the present disclosure enable an effective and reliable way to deploy and control a fleet of base station mounted drones, while also controlling the flow of data and communications between the drones and the terrestrial base stations in order to provide services to the extended coverage areas.

According to example embodiments, an apparatus is provided. The apparatus may be configured to: perform dual connectivity operation comprising a primary connection operation and a secondary connection operation; wherein the primary connection operation may include: receive, from a satellite, drone control data comprising data associated with control of a target drone; and control the target drone based on the drone control data; and wherein the secondary connection operation may include: receive, from an intermediate drone, service data comprising data associated with services using mmWave spectrum; and transmit the service data to a device under a coverage area associated with the target drone and to a forward drone using the mmWave spectrum.

According to example embodiments, a method is provided. The method may include: performing dual connectivity operation comprising a primary connection operation and a secondary connection operation; wherein the primary connection operation may include: receiving, from a satellite, drone control data comprising data associated with control of a target drone; and controlling the target drone based on the drone control data; and wherein the secondary connection operation may include: receiving, from an intermediate drone, service data comprising data associated with services using mmWave spectrum; and transmitting the service data to a device under a coverage area associated with the target drone and to a forward drone using the mmWave spectrum.

According to example embodiments, a non-transitory computer-readable recording medium is provided. The non-transitory computer-readable recording medium may have recorded thereon instructions executable by an apparatus to cause the apparatus to perform a method including: performing dual connectivity operation comprising a primary connection operation and a secondary connection operation; wherein the primary connection operation may include: receiving, from a satellite, drone control data comprising data associated with control of a target drone; and controlling the target drone based on the drone control data; and wherein the secondary connection operation may include: receiving, from an intermediate drone, service data comprising data associated with services using mmWave spectrum; and transmitting the service data to a device under a coverage area associated with the target drone and to a forward drone using the mmWave spectrum.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1A to FIG. 1B illustrate an example system architecture, according to one or more example embodiments;

FIG. 2 illustrates an example integrated access and backhaul (IAB) configuration associated with a secondary connection operation, according to one or more example embodiments;

FIG. 3 illustrates a flow diagram of an example method for performing primary connection operation, according to one or more example embodiments;

FIG. 4 illustrates a flow diagram of an example method for performing secondary connection operation, according to one or more example embodiments;

FIG. 5 illustrates an embodiment of a device for implementing one or more example embodiments; and

FIG. 6 illustrates a diagram of an example of implementation environment in which systems and/or method, described herein, may be implemented.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part). Further, the order of one or more operations may be switched, as long as these modifications may not affect the resulting scope of the present disclosure.

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B. Further still, where only one item is intended, the term “one” or similar language is used.

Expressions such as “at least one processor,” where configured to implement a plurality of operations, execute a plurality of instructions, etc., are to be understood as a single processor implementing the plurality of operations, etc., or each of plural processors implementing at least some (but not necessarily all) of the plurality of operations, etc.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Further, the described features, advantages, and characteristics of the present disclosure may be combined in any suitable manner in one or more example embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

The foregoing disclosure provides illustration and description but is not intended to be exhaustive or to limit the implementations to the precise form disclosed. Modifications and variations are possible in light of the above disclosure or may be acquired from practice of the implementations.

It shall be noted that, descriptions of example embodiments of the present disclosure may include terms and names defined in one or more standard organizations, such as the 3rd Generation Partnership Project (3GPP) standard organization, the European Telecommunications Standards Institute (ETSI) standard organization, the Open Radio Access Network (O-RAN) Alliance standard organization, and the like. For instance, the terms “IAB”, “DTC”, “mmWave”, “dual connectivity”, and the like, as well as the associated features and operations, are to be interpreted as consistent with those specified in one or more technical specifications, unless described otherwise.

Further, example embodiments of the present disclosure may be applied to any suitable network elements in any suitable telecommunication system, such as a 4G LTE system, a 5G NR system, a 6G system, satellite specific radio, and the like, without departing from the scope of the present disclosure.

As described above, base station mounted drone enables extension of the overall coverage area of the network by deploying base stations, via the drone, at remote locations that are usually outside of the coverage area provided by terrestrial base stations and locations encountering natural disasters.

In the related art, there is no solution to effectively and reliably deploy and control a fleet of base station mounted drones, while also controlling the flow of data and communications between the drones and the terrestrial base stations in order to provide services to the extended coverage areas.

Accordingly, system, methods, devices, and the like, provided in the example embodiments of the present disclosure automatically perform drone base station control.

According to example embodiments, the apparatus may be configured to perform dual connectivity operation which may include a primary connection operation and a secondary connection operation. Here, the primary connection operation may include receive drone control data comprising data associated with control of a target drone from a satellite, and then control the target drone based on the drone control data. On the other hand, the secondary connection operation may include receive service data comprising data associated with services using mmWave spectrum from an intermediate drone, and then transmit the service data to a device under a coverage area associated with the target drone and to a forward drone using the mmWave spectrum.

Ultimately, example embodiments of the present disclosure automatically perform drone base station control, which enables an effective and reliable way to deploy and control a fleet of base station mounted drones, while also controlling the flow of data and communications between the drones and the terrestrial base stations in order to provide services to the extended coverage areas.

It is contemplated that features, advantages, and significances of example embodiments described hereinabove are merely a portion of the present disclosure, and are not intended to be exhaustive or to limit the scope of the present disclosure.

Further descriptions of the features, components, configuration, operations, and implementations of the system of the present disclosure, according to one or more embodiments, are provided in the following.

### Example System Architecture

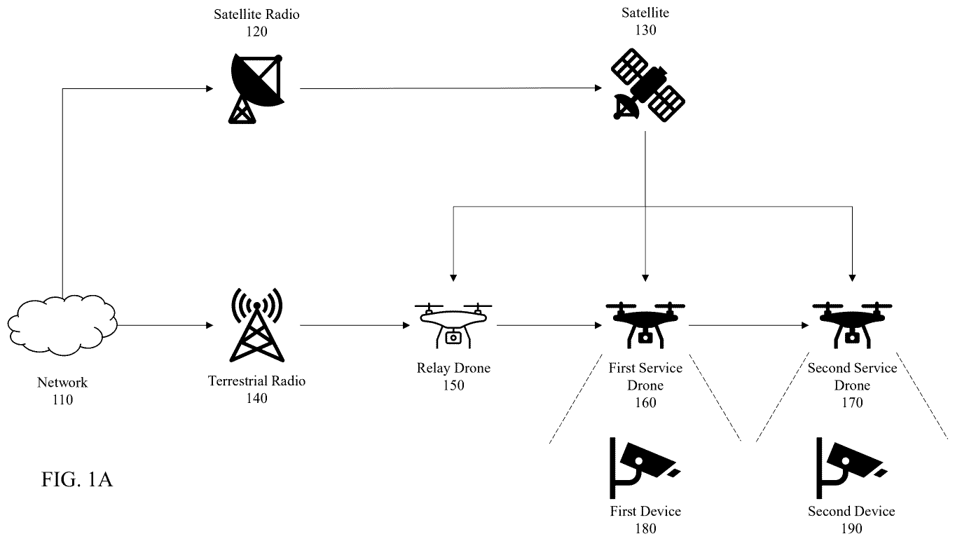

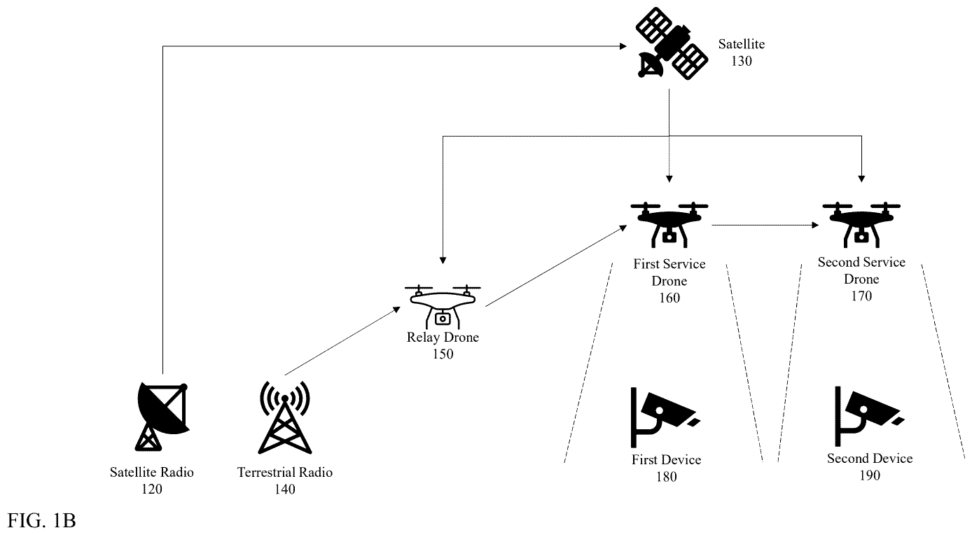

FIG. 1A to FIG. 1B illustrate an example system architecture, according to one or more example embodiments. As illustrated in FIG. 1A to FIG. 1B, the system architecture may include at least a network 110, a satellite radio 120, a satellite 130, a terrestrial radio 140, a relay drone 150, a plurality of service drones (first service drone 160 and second service drone 170), and a plurality of devices (first device 180 and a second device 190). It is contemplated that the system architecture may include more/fewer components than illustrated, and/or may be configured in a different manner, without departing from the scope of the present disclosure. For instance, in some implementations, the system architecture may include any number of relay drones, any number of service drones, any number of devices, and the like.

The network 100 may include various components of a network, such as a core (e.g., 5G core), a centralized unit (CU), and the like. The network 100 may be communicatively coupled to the satellite radio 120 in order to provide drone control data associated with primary connection operation to the service drones (first service drone 160 and second service drone 170) via the satellite radio 120 and the satellite 130. The network 100 may also be communicatively coupled to the terrestrial radio 140 in order to provide service data associated with secondary connection operation to the service drones (first service drone 160 and second service drone 170) via the terrestrial radio 140 and the relay drone 150.

Here, the service data may include data associated with services (e.g., cellular services) provided to devices connected under the coverage area of the service drones (first device 180 and second device 190), while the drone control data may include data associated with the control and configuration of the relay drones and service drones (relay drone 150, first service drone 160, and second service drone 170).

Here, the device may include any kind of device, user equipment (UE), and the like that is communicatively coupled to the network to utilize services. For example, the device may include a surveillance camera, a smart phone, and the like.

In this regard, the network 100 may include any components associated with the drone control data and service data. For example, the network 100 may include: drone flight control server configured to provide data associated with flight control of the relay drones and service drones, integrated access and backhaul (IAB) radio access network (RAN) control server configured to provide data associated with integrated access and backhaul (IAB) technique implemented at the secondary connection operation, service server configured to provide data associated with services provided to the devices (e.g., video surveillance server configured to provide services associated with video surveillance to camera (device) connected under the coverage area of the service drones), common data base configured to store various data associated with the drone control data and service data.

The satellite radio 120 may include a radio station located at a ground level that may be communicatively coupled to the satellite 130 which may be located above ground in the orbit of the earth (e.g., low orbit). The satellite radio 120 may be configured to receive the drone control data associated with primary connection operation from the network 110, and forward the drone control data to the satellite 130 in the orbit, where the satellite 130 may then forward the drone control data to the relay drones and service drones (relay drone 150, first service drone 160, and second service drone 170).

In this regard, according to example embodiments, the communications of the drone control data between the network 110 to the relay drones and service drones (relay drone 150, first service drone 160, and second service drone 170) through the satellite radio 120 and the satellite 130 may be part of the primary connection operation and may be performed using direct to cell (DTC) technique. The DTC may refer to a satellite-based radio cell used for end user connectivity, where the cells may be transmitted from low orbit satellite which covers a significantly large area on the ground to connect with the network.

The terrestrial radio 140 may include a radio station located at a ground level that may be communicatively coupled to the relay drone 150. The terrestrial radio 140 may be configured to receive the service data associated with secondary connection operation from the network 110, and forward the service data to the relay drone 150, where the relay drone 150 may then forward the service data to the service drones (first service drone 160 and second service drone 170). According to example embodiments, the terrestrial radio 140 may include a distributed unit (DU) and a centralized unit (CU).

In this regard, according to example embodiments, the communications of the service data between the network 110 to the service drones (first service drone 160 and second service drone 170) through the terrestrial radio 140 and the relay drone 150 may be part of the secondary connection operation and may be performed using integrated access and backhaul (IAB) technique through line of sight (LOS).

According to example embodiments, the secondary connection operation may also be performed using mmWave spectrum. The high bandwidth capacity of the mmWave may provide high data rate for the service data, which may be crucial as the service data may need to be provided to the extended coverage area at remote locations via multiple drones. Further, the mmWave may enable efficient transfer of data when utilized at a certain altitude and elevation above ground, which is where the service drones may be located.

Additionally, the mmWave spectrum may enable usage of a wireless backhaul solution (e.g., for 5G new radio), such as the integrated access and backhaul (IAB), to densify networks with multi-band radio sites at ground level. In particular, for example, the IAB may thoroughly utilize the mmWave spectrum allotted for 5G for backhaul connectivity in high density multiband radio deployments. As such, the IAB may provide flexible and scalable multi-hop backhauling, using the same or different frequency bands for access and backhaul.

Further, the IAB may be defined to utilize existing functions and interfaces (e.g., 5G NR functions and interfaces), as well as to minimize impact on the core network. From a transport perspective, IAB may provide generic IP connectivity to enable an easy upgrade to fiber transport when needed.

The first service drone 160 and second service drone 170 may include, for example, unmanned aerial vehicle (UAV), although it is understood that the present disclosure is not limited thereto and may encompass any other kind of drones.

Each of the first service drone 160 and second service drone 170 may be associated with a coverage area (shown as dotted lines in FIG. 1A to FIG. 1B), where devices under a particular coverage area of a particular service drone may receive service data from such particular service drone. In the example shown in FIG. 1A to FIG. 1B, the first device 180 is under the coverage area of the first service drone 160, while the second device 190 is under the coverage area of the second service drone 170, although it is understood that the number of devices under a particular coverage area of a particular service drone can be any number. According to example embodiments, a coverage area may correspond to a cell of a network or to a portion of a cell of a network.

As such, the system architecture and the extension of the coverage area of the network may be scalable through the deployment of the service drones, and the number of backhaul hops may be defined by network performance.

In this regard, the first service drone 160 and second service drone 170 may receive service data from the relay drone 150 in series, where the first service drone 160 may receive service data from the relay drone 150, transmit the service data (service data that is associated with service to provide to the first device 180) to the first device 180 that is under the coverage area of the first service drone 160 in order to provide the service to the first device 180, and then transmit the service data (service data that is associated with service to provide to the second device 190) to the second service drone 170. Subsequently, the second service drone 170 may receive service data from the first service drone 160, and transmit the service data (service data that is associated with service to provide to the second device 190) to the second device 190 that is under the coverage area of the second service drone 170 in order to provide the service to the second device 190.

As such, the transmission of the service data from a service drone may be performed as a dual beam, with one directed to the device under the associated coverage area and another directed at the next in-line service drone (forward drone).

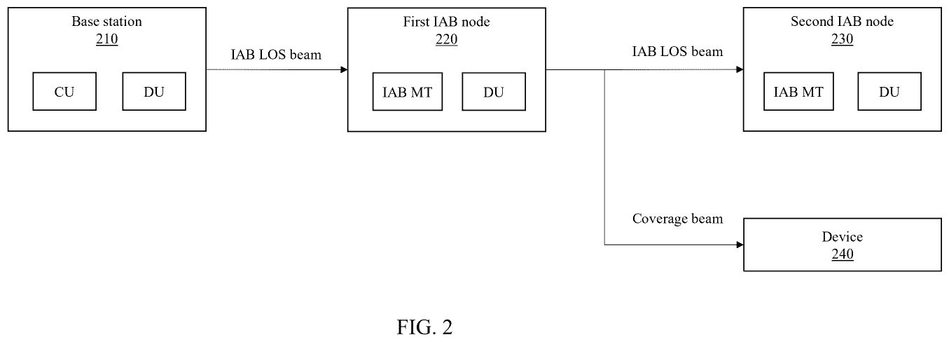

FIG. 2 illustrates an example integrated access and backhaul (IAB) configuration associated with the secondary connection operation, according to one or more example embodiments. As illustrated in FIG. 2, the IAB configuration may involve a base station 210, a first IAB node 220, a second IAB node 230, and a device 240.

The base station 210 may correspond to the network 110, terrestrial radio 140, and the relay drone 150 described above in relation to FIG. 1A to FIG. 1B. Similarly, the first IAB node 220, second IAB node 230, and device 240 may correspond to first service drone 160, second service drone 170, and first device 180 described above in relation to FIG. 1A to FIG. 1B.

The base station may include a centralized unit (CU) and a distributed unit (DU), with the DU having a direct connectivity to the CU. According to example embodiments, the base station may be considered as a doner base station. Further, each of the first IAB node 220 and the second IAB node 230 may include an IAB mobile termination (MT) function and a DU.

Here, the base station 210 may be configured to transmit service data (backhaul) across wirelessly interconnected nodes (first IAB node 220 and the second IAB node 230; service drones), with the backhaul links terminated by the IAB MT function.

In particular, the base station may transmit service data to the first IAB node 220 via an IAB line of sight (LOS) beam, where the IAB LOS beam may be terminated at the IAB MT of the first IAB node 220. Subsequently, the first IAB node 220 may transmit the service data to the second IAB node 230 via an IAB LOS beam, as well as to the device 240 via a coverage beam (i.e., dual beam). In this regard, the IAB MT may utilize separate antennas for IAB LOS beam and coverage beam, or share the access antenna for IAB LOS beam and coverage beam using virtual IAB MT. The latter may provide high level of integration, as well as utilizing the high-performance antennas for backhaul over longer distances.

Returning to FIG. 1A to FIG. 1B, from the perspective of the first service drone 160, the first service drone 160 may be considered as a target drone, while the relay drone 150 may be considered as an intermediate drone (drone which the target drone receives the service data from), and the second service drone 170 may be considered as a forward drone (drone which the target drone transmits/forwards the service data to). Similarly, from the perspective of the second service drone 170, the second service drone 170 may be considered as a target drone, while the first service drone 160 may be considered as an intermediate drone (drone which the target drone receives the service data from), and a third service drone (not shown) may be considered as a forward drone (drone which the target drone transmits/forwards the service data to).

Further, the first service drone 160 and second service drone 170, as well as the relay drone 150, may be controlled based on drone control data received from the satellite 130.

In this regard, according to example embodiments, the first service drone 160 and second service drone 170 may be configured to perform dual connectivity operation, which may include the primary connection operation associated with the drone control data received through the satellite radio 120 and the satellite 130 using the DTC technique, and the secondary connection operation associated with the service data received through the terrestrial radio 140 and the relay drone 150 (and any intermediate drone) using the IAB technique.

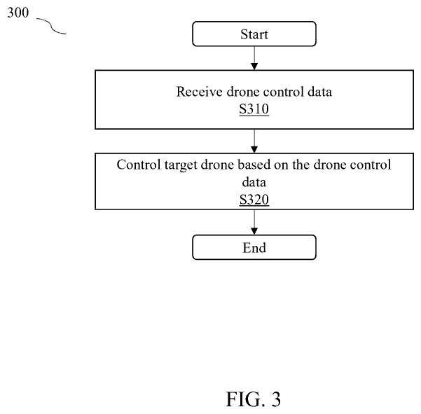

Examples of operations associated with the primary connection operation are described below with reference to FIG. 2, while examples of operations associated with the secondary connection operation are described below with reference to FIG. 3.

Here, the relay drone 150 may include, for example, unmanned aerial vehicle (UAV), in the similar manner as the first service drone 160 and second service drone 170. The relay drone 150 may act as a relay between the terrestrial radio 140 and the service drones, and may be located at a location (elevation) between the terrestrial radio 140 and the service drones. In this regard, the relay drone 150 may receive the service data from the terrestrial radio 140 and forward such service data to the first service drone 160, without being associated with a coverage area or providing any service data to any devices.

The involvement of the relay drone 150 allows the service drones to be positioned at an appropriate elevation and location away from the terrestrial radio 140 to provide services to the devices under their coverage areas, without concern regarding the distance or line of sight to the terrestrial radio 140.

In particular, FIG. 1B shows an example positional relationships between the components of the system architecture. As shown in FIG. 1B, the satellite radio 120, the terrestrial radio 140, the first device 180 and the second device 190 may be located at the ground level; the first service drone 160 and second service drone 170 may be located at a particular elevation above the ground level; the relay drone 150 may be located at an elevation between the ground level and the first service drone 160 and second service drone 170 to facilitate relaying of service data from the terrestrial radio 140 to the first service drone 160 and second service drone 170; and the satellite may be located at the orbit of the earth above the first service drone 160 and second service drone 170.

### Example Operations for Performing Drone Base Station Control in the Present Disclosure

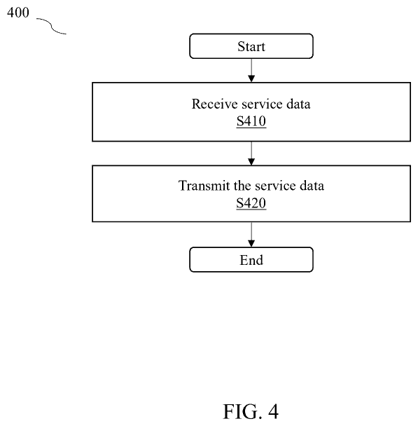

In the following, several example operations are performable by the apparatus of one or more example embodiments of the present disclosure are described with reference to FIG. 3 to FIG. 4

Here, the apparatus may be configured to perform drone base station control, and may include a target drone. The target drone may include one of a plurality of service drones (e.g., first service drone 160 and second service drone 170). Further, as described above, the target drone may be configured to perform dual connectivity operation, which may include a primary connection operation and a secondary connection operation.

FIG. 3 illustrates a flow diagram of an example method 300 for performing primary connection operation, according to one or more example embodiments. The primary connection operation may be performed using direct to cell (DTC) technique.

As illustrated in FIG. 3, at operation S310, the apparatus may be configured to receive drone control data. The drone control data may be received from a satellite, and may include data associated with control of the target drone.

According to example embodiments, the drone control data may include at least one of: IAB RAN control data associated with a control and configuration of integrated access and backhaul (IAB) technique implemented at the secondary connection operation; and drone flight control data associated with a control and configuration of flight of the target drone.

The IAB RAN control data may include, for example, data associated with control and configuration of the IAB (e.g., frequency, power, etc.), data associated with power for battery saving, and the like. The drone flight control data may include, for example, data associated with control of the flight of the drone (altitude, positional 3D mapping, flight duration, etc.), data associated with drone battery power, and the like. The method then proceeds to operation S320.

At operation S320, the apparatus may be configured to control the target drone based on the drone control data.

For example, the drone control data may include drone flight control data specifying an elevation of the target drone. Accordingly, the apparatus (target drone) may position itself at the elevation specified in the drone control data during operation S320.

In another example, the drone control data may include IAB RAN control data specifying a cell configuration where the coverage area of the target drone (to which the service data is to be provided) is configured as an individual cell of a network, which may be part of a cell group. In further another example, the drone control data may include IAB RAN control data specifying a cell configuration where the coverage area of the target drone (to which the service data is to be provided) is configured as part (portion) of a single cell that is formed from a plurality of coverage areas of a plurality of service drones.

Upon performing operation S320, the method 300 may be ended or be terminated. Alternatively, method 300 may return to operation S310, such that the at least one processor may be configured to repeatedly perform, for at least a predetermined amount of time, the receiving the drone control data (at operation S310), and the controlling the target drone (at operation S320).

FIG. 4 illustrates a flow diagram of an example method 400 for performing secondary connection operation, according to one or more example embodiments. The secondary connection operation may be performed using integrated access and backhaul (IAB) technique.

As illustrated in FIG. 4, at operation S410, the apparatus may be configured to receive service data. The service data may be received from an intermediate drone, and may include data associated with services. The intermediate drone may include a relay drone or a service drone.

According to example embodiments, the service data may be received using mmWave spectrum.

According to example embodiments, the service data may include at least one of: data associated with services to provide to the coverage area associated with the target drone; and data associated with services to provide to a coverage area associated with a forward drone.

The service data may include, for example data associated with cell coverage and data streams, data for connectivity of services (e.g., surveillance), and the like. The method then proceeds to operation S420.

At operation S420, the apparatus may be configured to transmit the service data to a device under a coverage area associated with the target drone and to the forward drone. The forward drone may include a service drone that is next in-line from the target drone.

According to example embodiments, the service data may be transmitted using mmWave spectrum.

According to example embodiments, the data associated with services to provide to the coverage area associated with the target drone in the service data may be transmitted to the device, while the data associated with services to provide to the coverage area associated with the forward drone may be transmitted to the forward drone.

The coverage area associated with the target drone may correspond to a cell of a network or to a portion of a cell of a network.

Upon performing operation S420, the method 400 may be ended or be terminated. Alternatively, method 400 may return to operation S410, such that the at least one processor may be configured to repeatedly perform, for at least a predetermined amount of time, the receiving the service data (at operation S410), and the transmitting the service data (at operation S420).

Here, the apparatus may include the target drone that may include a first service drone configured to provide service to a coverage area associated with the first service drone. Further, the forward drone may include a second service drone configured to provide service to a coverage area associated with the second service drone. Furthermore, the intermediate drone may include a relay drone configured to relay service from a terrestrial radio to the first service drone or a third service drone configured to provide service to a coverage area associated with the third service drone.

In view of the above, the above processes enable an effective and reliable way to deploy and control a fleet of base station mounted drones, while also controlling the flow of data and communications between the drones and the terrestrial base stations in order to provide services to the extended coverage areas.

In particular, the utilization of dual connectivity operation for drone control (i.e., primary connection operation) and service provision (i.e., secondary connection operation) allows the drones to reliably and efficiently receive and transmit service data for their respective coverage areas, while also receive drone control data for controlling the drones themselves.

Further, the use of IAB technique for the secondary connection operation with the mmWave spectrum allows the service data to be effectively transmitted from the terrestrial through multiple drones at high altitude/elevation across a long distance to the devices.

Furthermore, the use of DTC technique for the primary connection operation allows the drone control data to be reliably transmitted from the satellite to the drones, and ensures that the drones are always controllable and manageable at all time and at any location.

### Various Aspects of Embodiments

In view of the above, example embodiments of the present disclosure enable an effective and reliable way to deploy and control a fleet of base station mounted drones, while also controlling the flow of data and communications between the drones and the terrestrial base stations in order to provide services to the extended coverage areas.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s) module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

One or more components of the apparatus of the example embodiments (e.g., service drone, etc.), as well as the operations associated therewith (e.g., dual connectivity operation, one or more operations in FIG. 3 to FIG. 4, etc.), may be implemented in one or more systems, devices, or hardware components, such as one or more servers, and the like. In the following, descriptions of a device in which the systems or components of the example embodiments may be implemented are provided. It is contemplated that one or more operations or methods described above with reference to FIG. 1 to FIG. 4 may be performed by the device. For instance, the one or more operations or methods may be performed by at least one processor of the device upon executing machine-readable instructions or computer-readable instructions stored in a memory or a storage component of the device.

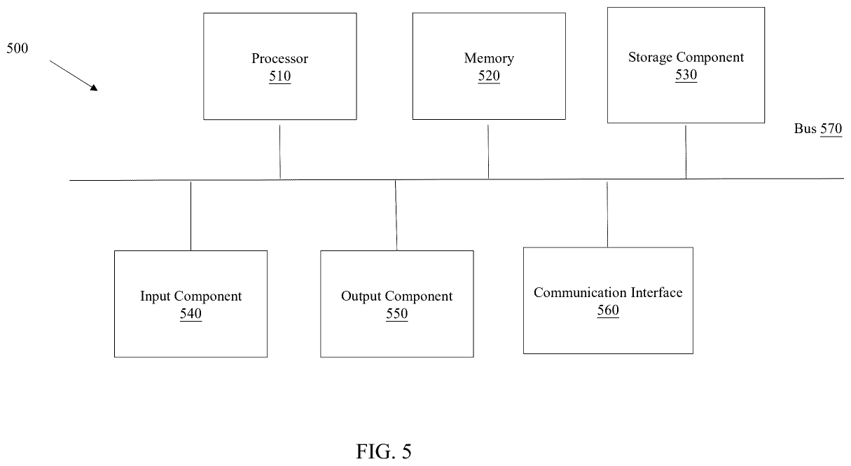

FIG. 5 illustrates an embodiment of a device 500 for implementing one or more example embodiments. As shown in FIG. 5, the device 500 includes a processor 510, a memory 520, a storage component 530, an input component 540, an output component 550, a communication interface 560, and a bus 570.

The processor 510, as used herein, means any type of computational circuit that may comprise hardware elements and software elements. The processor 510 may be embodied as a multi-core processor, a single core processor, or a combination of one or more multi-core processors and one or more single core processors, a distributed processing system, or the like. The processor 510 may be a Central Processing Unit (CPU), a graphics processing unit (GPU), an accelerated processing unit (APU), an application-specific integrated circuit (ASIC), or another type of processing component.

Memory 520 includes a non-transitory computer readable medium. Memory 520 includes a random-access memory (RAM), a read only memory (ROM), and/or another type of dynamic or static storage device (e.g., a flash memory, a magnetic memory, and/or an optical memory) that stores information and/or instructions for use by processor 510. The memory 520 comprises machine-readable instructions which are executable by the processor 510. These machine-readable instructions when executed by the processor 510 causes the processor 510 to perform one or more method steps of an embodiment described herein.

Storage component 530 stores information and/or software related to the operation and use of the device 500. For example, storage component 530 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 540 is configured to receive information, such as user input. For example, the input component 540 may include, but not be limited to, a touch screen display, a keyboard, a keypad, a mouse, a button, a switch, and/or a microphone. Additionally, or alternatively, the input component 540 may include a sensor for sensing information (e.g., a global positioning system (GPS), an accelerometer, a gyroscope, and/or an actuator).

Output component 550 is configured to provide output information from the device 500. For example, the output component 550 may be, but not limited to, a display, a speaker, an instruction device to an external device, and/or one or more light-emitting diodes (LEDs).

Communication interface 560 is an interface that provides a communication connection to other devices, such as external devices and internal devices. The connection by the communication interface 560 can be a wired connection, a wireless connection, or a combination of wired and wireless connections, and can be a direct connection or an indirect connection via a communication network that exists between the device 500 and other devices. In other words, the standard of the communication interface 560 is not limited.

The bus 570 acts as an interconnect between the processor 510, the memory 520, the storage component 530, the input component 540, the output component 550, and the communication interface 560 of the device 500. The bus 570 may include a wired interconnection or a wireless interconnection.

The number and arrangement of components shown in FIG. 5 are provided as an example. In practice, device 500 may include additional components, fewer components, different components, or differently arranged components than those shown in FIG. 5. Additionally, or alternatively, a set of components (e.g., one or more components) of device 500 may perform one or more functions described as being performed by another set of components of device 500. Further, one or more method steps described in any of the embodiments may be performed utilizing a plurality of device 500 in communication with one another.

Further, according to example embodiments, the device 500 may include one or more elements from the system architecture described above in relation to FIG. 1A to FIG. 1B. For example, the device 500 may include the first service drone 160, or the second service drone 170.

In the present disclosure, specific tasks may be performed using AI/ML (Artificial Intelligence/Machine Learning) models. An AI/ML model is a model generated using one or more AI technologies, one or more ML algorithm or both, and generates output data based on input data. This output data is used to perform tasks. Tasks performed using AI/ML models include those generally referred to as intellectual tasks, such as classification, prediction, natural language processing, etc.

Although AI and ML are explained separately, ML is a technology included in AI. In ML, instead of being explicitly programmed for a specific task, systems can improve their performance over time by identifying patterns and making inferences from training data. Typically, the generation of ML models includes data collection, model training, and model inference. Data collection involves gathering and preprocessing data to be used for training and inference. Model training involves developing and validating models using the collected data. Model inference involves applying the trained models to new data to generate new output data and perform tasks.

Machine learning includes various types of learning methods such as supervised learning, unsupervised learning, reinforcement learning, semi-supervised learning, self-supervised learning, transductive learning, transfer learning, meta learning, and the like. These types of learning methods can be appropriately selected according to the embodiments. Unless otherwise specified, the application of types not mentioned in this description is not precluded. Additionally, the structure of ML models may vary depending on the embodiments and learning methods, and is not limited to the methods disclosed. Furthermore, ML includes deep learning, which uses models that include neural networks. Deep learning models may include, for example, deep neural networks (DNNs), convolutional neural networks (CNNs), etc.

It should be noted that the AI/ML models presented hereinafter are examples and are not limited to the illustrated AI/ML models. They can be modified or altered by using different AI or ML algorithms. The configuration of the neural network is not limited to the configuration disclosed in the present disclosure and can be modified.

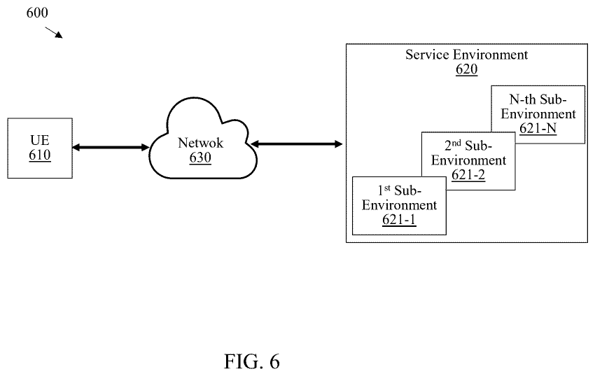

FIG. 6 is a diagram of an example of implementation environment 600 in which systems and/or method, described herein, may be implemented. The implementation environment 600 includes a UE (User equipment) 610, a service environment 620, and a network 630. The service environment 620 include one or more sub-environments 621. To illustrate this, FIG. 6 shows, for convenience, examples of a 1st sub-environment 621-1, a 2nd sub-environment 621-2, and an N-th sub-environment 621-N (where N is any natural number).

The UE 610 is connected to the network 630, and the network 630 is connected to the service environment 620. The connections may be wired, wireless, or a combination of both wired and wireless. The UE 610 and the service environment 620 are connected via the network 630.

The UE 610 is a device that communicates with the service environment 620. The UE 610 receives information from the service environment 620 and/or sends information to the service environment 620. Also, the UE 610 may generate and/or store information to be transmitted, as necessary. Also, the UE 610 may store and/or process information that is received, as necessary.

The example FIG. 6 refers to the “UE”. However, it should be understood by those skilled in the art that general terms such as “user device,” “terminal,” “terminal device,” “communication device,” and “communication terminal” can be used interchangeably with the term “UE.”

For example, the UE 610 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device.

The service environment 620 is an environment that communicates with the UE 610 to provide one or more services. The service environment 620 receives information from the UE 610 and/or sends information to the UE 610. Also, the service environment 620 may generate and/or store information to be transmitted, as necessary. Also, the service environment 620 may store and/or process information that is received, as necessary. For example, the service environment 620 may provide computing resources as one of the services. It should be noted that the service is not limited to being provided to the UE; it may also be provided to devices other than the UE. For example, based on communication from the UE, the service may perform processes such as anomaly detection or traffic analysis and notify the results to a predetermined destination.

The example FIG. 6 refers to the “service environment”. The term “service environment” is used to refer to the broader context within which services operate. For example, cloud environments, platforms, computing systems, network systems, and cloud systems generally represent the environments in which services are conducted, and these are included within the “service environment.” However, the “service environment” is not limited to these examples. Additionally, the specific types of environments within the “service environment” are not restricted. For instance, cloud environments and cloud systems can be categorized as private cloud, public cloud, hybrid cloud, or multi-cloud, all of which are included within the “service environment.”

The one or more services provided by the service environment 620 is not specifically limited and can be adjusted according to the embodiments. For example, the services may include a service that provides information to the UE 610, a service that stores information from the UE 610, or a service that performs processing based on information from the UE 610 and returns the results of the processing.

In an embodiment, the Service Environments 620 may also provide computing resources as the service. The computing resources can be hardware resources and/or software resources. For example, applications, processors, memory, and storage can be included in the provided computing resources. Each computing resource can communicate with other computing resources via wired connections, wireless connections, or a combination of wired and wireless connections.

The provided computing resources can be actual resources (also referred to as physical resources) and/or virtual resources. Furthermore, means of virtualization for virtual resources can be selected as appropriate. That is, in this disclosure, the use of adjectives such as “Virtual” or “Virtualized” to describe names does not imply that they are virtualized by a specific means of virtualization. For example, “virtual machine” refers to software that operates like an actual computer, realized through means of virtualization, and it is not intended to exclude those realized by specific means of virtualization such as Hypervisors or Containers. Conversely, when means of virtualization such as Hypervisors or containers are mentioned in this disclosure, it is merely cited as a general method of implementation. It should also be interpreted that embodiments implemented with other virtualization means are also disclosed. Also, the services may also be provided using resources virtualized by different means.

The service environment 620 includes one or more devices, such as servers and network devices, which provide services or perform processes. The placement of these devices within the service environment 620 can be determined as appropriate. Additionally, if the service environment 620 includes one or more sub-environments 621, the placement of devices can be determined based on predetermined policies for each sub-environment 621. For example, devices related to the first service may be placed in the 1st sub-environment 621-1, and devices related to the second service may be placed in the 2nd sub-environment 621-2. In another example, devices expected to have a higher load than a predetermined threshold may be placed in the 1st sub-environment 621-1, while devices expected to have a lower load than the predetermined threshold may be placed in the 2nd sub-environment 621-2. In this way, specific devices can be placed in specific sub-environments 621. Conversely, each sub-environment 621 can be specialized for a particular purpose.

In an embodiment, all processes executed in a single service may run within a single service environment, or in multiple service environments. Multiple processes executed in a single service could be provided by different service environments.

The network 630 is a network that exchanges information between the UE 610 and the service environment 620. The network 630 includes one or more wired and/or wireless networks.

For example, the network 630 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, a non-terrestrial network (NTN), and/or a combination of these or other types of networks.

The network 630 can be a part of a network. For example, in a 5G network that includes a RAN, a transport network, and a core network, the network 630 can be at least one of the RAN, the transport network, or the core network. For example, the service environment 620 could be in the core network, in which case the network 630 could correspond to a network that is a combination of a RAN and a transport network and is part of the 5G network.

The number and arrangement of devices and networks shown in FIG. 6 are provided as an example. It should be understood that any changes that may be implemented by those skilled in the art, such as the addition or rearrangement of well-known devices or networks at the time of implementation, are included in this disclosure.

Various further respective aspects and features of embodiments of the present disclosure may be defined by the following items:
Item [1]: An apparatus that may be configured to: perform dual connectivity operation comprising a primary connection operation and a secondary connection operation; wherein the primary connection operation may include: receive, from a satellite, drone control data comprising data associated with control of a target drone; and control the target drone based on the drone control data; and wherein the secondary connection operation may include: receive, from an intermediate drone, service data comprising data associated with services using mmWave spectrum; and transmit the service data to a device under a coverage area associated with the target drone and to a forward drone using the mmWave spectrum.
Item [2]: The apparatus according to item [1], wherein the primary connection operation may be performed using direct to cell (DTC) technique.
Item [3]: The apparatus according to one of items [1]-[2], wherein the secondary connection operation may be performed using integrated access and backhaul (IAB) technique.
Item [4]: The apparatus according to one of items [1]-[3], wherein the coverage area associated with the target drone may correspond to a cell of a network or to a portion of a cell of a network.
Item [5]: The apparatus according to one of items [1]-[4], wherein the drone control data may include at least one of: IAB RAN control data associated with a control and configuration of integrated access and backhaul (IAB) technique implemented at the secondary connection operation; and drone flight control data associated with a control and configuration of flight of the target drone.
Item [6]: The apparatus according to one of items [1]-[5], wherein the service data may include at least one of: data associated with services to provide to the coverage area associated with the target drone; and data associated with services to provide to a coverage area associated with the forward drone.
Item [7]: The apparatus according to one of items [1]-[6], wherein the apparatus may include the target drone that may include a first service drone configured to provide service to the coverage area associated with the first service drone, wherein the forward drone may include a second service drone configured to provide service to a coverage area associated with the second service drone, and wherein the intermediate drone may include a relay drone configured to relay service from a terrestrial radio to the first service drone or a third service drone configured to provide service to a coverage area associated with the third service drone.
Item [8]: A method that may include: performing dual connectivity operation comprising a primary connection operation and a secondary connection operation; wherein the primary connection operation may include: receiving, from a satellite, drone control data comprising data associated with control of a target drone; and controlling the target drone based on the drone control data; and wherein the secondary connection operation may include: receiving, from an intermediate drone, service data comprising data associated with services using mmWave spectrum; and transmitting the service data to a device under a coverage area associated with the target drone and to a forward drone using the mmWave spectrum.
Item [9]: The method according to item [8], wherein the primary connection operation may be performed using direct to cell (DTC) technique.
Item [10]: The method according to one of items [8]-[9], wherein the secondary connection operation may be performed using integrated access and backhaul (IAB) technique.
Item [11]: The method according to one of items [8]-[10], wherein the coverage area associated with the target drone may correspond to a cell of a network or to a portion of a cell of a network.
Item [12]: The method according to one of items [8]-[11], wherein the drone control data may include at least one of: IAB RAN control data associated with a control and configuration of integrated access and backhaul (IAB) technique implemented at the secondary connection operation; and drone flight control data associated with a control and configuration of flight of the target drone.
Item [13]: The method according to one of items [8]-[12], wherein the service data may include at least one of: data associated with services to provide to the coverage area associated with the target drone; and data associated with services to provide to a coverage area associated with the forward drone.
Item [14]: The method according to one of items [8]-[13], wherein the method may be performed by the target drone that may include a first service drone configured to provide service to the coverage area associated with the first service drone, wherein the forward drone may include a second service drone configured to provide service to a coverage area associated with the second service drone, and wherein the intermediate drone may include a relay drone configured to relay service from a terrestrial radio to the first service drone or a third service drone configured to provide service to a coverage area associated with the third service drone.
Item [15]: A non-transitory computer-readable recording medium that may have recorded thereon instructions executable by an apparatus to cause the apparatus to perform a method including: performing dual connectivity operation comprising a primary connection operation and a secondary connection operation; wherein the primary connection operation may include: receiving, from a satellite, drone control data comprising data associated with control of a target drone; and controlling the target drone based on the drone control data; and wherein the secondary connection operation may include: receiving, from an intermediate drone, service data comprising data associated with services using mmWave spectrum; and transmitting the service data to a device under a coverage area associated with the target drone and to a forward drone using the mmWave spectrum.
Item [16]: The non-transitory computer-readable recording medium according to item [15], wherein the primary connection operation may be performed using direct to cell (DTC) technique.
Item [17]: The non-transitory computer-readable recording medium according to one of items [15]-[16], wherein the secondary connection operation may be performed using integrated access and backhaul (IAB) technique.
Item [18]: The non-transitory computer-readable recording medium according to one of items [15]-[17], wherein the coverage area associated with the target drone may correspond to a cell of a network or to a portion of a cell of a network.
Item [19]: The non-transitory computer-readable recording medium according to one of items [15]-[18], wherein the drone control data may include at least one of: IAB RAN control data associated with a control and configuration of integrated access and backhaul (IAB) technique implemented at the secondary connection operation; and drone flight control data associated with a control and configuration of flight of the target drone.
Item [20]: The non-transitory computer-readable recording medium according to one of items [15]-[19], wherein the service data may include at least one of: data associated with services to provide to the coverage area associated with the target drone; and data associated with services to provide to a coverage area associated with the forward drone.

It is understood that numerous modifications and variations of the present disclosure are possible in light of the above teachings. It will be apparent that within the scope of the appended clauses, the present disclosures may be practiced otherwise than as specifically described herein.

What is claimed is:

1. An apparatus configured to:
perform a dual connectivity operation comprising a primary connection operation and a secondary connection operation;
wherein the primary connection operation comprises:
receiving, from a satellite, drone control data comprising data associated with control of a target drone; and
controlling the target drone based on the drone control data; and
wherein the secondary connection operation comprises:
receiving, from an intermediate drone, service data comprising data associated with services using mmWave spectrum; and
transmitting the service data to a device under a coverage area associated with the target drone and to a forward drone using the mmWave spectrum.

2. The apparatus according to claim 1, wherein the primary connection operation is performed using direct to cell (DTC) technique.

3. The apparatus according to claim 1, wherein the secondary connection operation is performed using integrated access and backhaul (IAB) technique.

4. The apparatus according to claim 1, wherein the coverage area associated with the target drone corresponds to a cell of a network or to a portion of a cell of a network.

5. The apparatus according to claim 1, wherein the drone control data comprises at least one of: IAB RAN control data associated with a control and configuration of integrated access and backhaul (IAB) technique implemented at the secondary connection operation; and drone flight control data associated with a control and configuration of flight of the target drone.

6. The apparatus according to claim 1, wherein the service data comprises at least one of: data associated with services to provide to the coverage area associated with the target drone; and data associated with services to provide to a coverage area associated with the forward drone.

7. The apparatus according to claim 1, wherein the apparatus comprises the target drone that comprises a first service drone configured to provide service to the coverage area associated with the first service drone, wherein the forward drone comprises a second service drone configured to provide service to a coverage area associated with the second service drone, and wherein the intermediate drone comprises a relay drone configured to relay service from a terrestrial radio to the first service drone or a third service drone configured to provide service to a coverage area associated with the third service drone.

8. A method comprising:
performing a dual connectivity operation comprising a primary connection operation and a secondary connection operation;
wherein the primary connection operation comprises:
receiving, from a satellite, drone control data comprising data associated with control of a target drone; and
controlling the target drone based on the drone control data; and
wherein the secondary connection operation comprises:
receiving, from an intermediate drone, service data comprising data associated with services using mmWave spectrum; and
transmitting the service data to a device under a coverage area associated with the target drone and to a forward drone using the mmWave spectrum.

9. The method according to claim 8, wherein the primary connection operation is performed using direct to cell (DTC) technique.

10. The method according to claim 8, wherein the secondary connection operation is performed using integrated access and backhaul (IAB) technique.

11. The method according to claim 8, wherein the coverage area associated with the target drone corresponds to a cell of a network or to a portion of a cell of a network.

12. The method according to claim 8, wherein the drone control data comprises at least one of: IAB RAN control data associated with a control and configuration of integrated access and backhaul (IAB) technique implemented at the secondary connection operation; and drone flight control data associated with a control and configuration of flight of the target drone.

13. The method according to claim 8, wherein the service data comprises at least one of: data associated with services to provide to the coverage area associated with the target drone; and data associated with services to provide to a coverage area associated with the forward drone.

14. The method according to claim 8, wherein the method is performed by the target drone that comprises a first service drone configured to provide service to the coverage area associated with the first service drone, wherein the forward drone comprises a second service drone configured to provide service to a coverage area associated with the second service drone, and wherein the intermediate drone comprises a relay drone configured to relay service from a terrestrial radio to the first service drone or a third service drone configured to provide service to a coverage area associated with the third service drone.

15. A non-transitory computer-readable recording medium having recorded thereon instructions executable by an apparatus to cause the apparatus to perform a method comprising:
performing dual connectivity operation comprising a primary connection operation and a secondary connection operation;
wherein the primary connection operation comprises:
receiving, from a satellite, drone control data comprising data associated with control of a target drone; and
controlling the target drone based on the drone control data; and
wherein the secondary connection operation comprises:
receiving, from an intermediate drone, service data comprising data associated with services using mmWave spectrum; and
transmitting the service data to a device under a coverage area associated with the target drone and to a forward drone using the mmWave spectrum.

16. The non-transitory computer-readable recording medium according to claim 15, wherein the primary connection operation is performed using direct to cell (DTC) technique.

17. The non-transitory computer-readable recording medium according to claim 15, wherein the secondary connection operation is performed using integrated access and backhaul (IAB) technique.

18. The non-transitory computer-readable recording medium according to claim 15, wherein the coverage area associated with the target drone corresponds to a cell of a network or to a portion of a cell of a network.

19. The non-transitory computer-readable recording medium according to claim 15, wherein the drone control data comprises at least one of: IAB RAN control data associated with a control and configuration of integrated access and backhaul (IAB) technique implemented at the secondary connection operation; and drone flight control data associated with a control and configuration of flight of the target drone.

20. The non-transitory computer-readable recording medium according to claim 15, wherein the service data comprises at least one of: data associated with services to provide to the coverage area associated with the target drone; and data associated with services to provide to a coverage area associated with the forward drone.
